(19) United States
(12) Patent Application Publication
(10) Pub. No.: US 2006/0242410 A1
(43) Pub. Date: Oct. 26, 2006

(54) Mobile device authentication with a data source using self-signed certificates

(75) Inventors: Omar Aftab, Redmond, WA (US); Liang Chen, Sammamish, WA (US); Jon Xu, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/114,438

(22) Filed: Apr. 26, 2005

(51) Int. Cl. H04L 9/00

(52) U.S. Cl. 713/171

(57) ABSTRACT

A system for authenticating a mobile computing device is disclosed. The system comprises an access credential module that creates and uses a self-signed access credential. The self-signed access credential indicates that a mobile computing device possessing the access credential is trusted. The system further comprises a data protection module that applies the access credential to data used by the mobile computing device. Methods for using the system are also disclosed.

### TECHNICAL FIELD

The disclosed invention relates generally to data communications and specifically to systems and methods for protecting data communications of mobile computing devices.

### BACKGROUND

A variety of mobile computing devices currently exist and use of such devices is becoming more prevalent. Common examples of such devices include personal information managers, personal digital assistants, palmtop computers, and cellular telephones. These devices usually include some type of data storage with associated functionality and data communication ability such as address book or contact information storage, calendar and scheduling, and note taking, among others. More sophisticated devices can usually store and use multiple file types and choose from among multiple types of data connections. Typical types of data connections include wired connections such as universal serial bus (USB), IEEE 1394, or others and wireless connections such as code division multiple access (CDMA), time division multiple access (CDMA), global system for mobile communications (GSM), IEEE 802.11x, and Bluetooth.

Mobile computing devices are commonly used in conjunction with a primary computer that is usually a desktop or laptop personal computer. The primary computer often provides data processing functions for the mobile computing device such as initial retrieval of electronic messages and data backup. It is not unusual for a copy of all data on a mobile computing device to be backed up to a storage device of the primary computer in case the data of the mobile computing device is corrupted or lost or the device itself is lost, stolen, or damaged. Generally, a mobile computing device can only access one primary computer for these functions although the mobile computing device may be able to access multiple secondary computers for these and other tasks.

When a mobile computing device is paired with a primary computer, an initial connection is usually made using a direct cable connection between the mobile computing device and the primary computer. A simple alphanumeric identifier is usually assigned to each of the machines so that each can recognize the other for data communication tasks. This arrangement has a number of drawbacks. For example, no means for protected communication between the devices is provided for times when the mobile computing device is not directly physically connected to the primary computer. The use of a simple alphanumeric identifier increases risks of data theft techniques such as man in the middle attacks and spoofing or impersonation. A mobile computing device should be able to mitigate these risks.

### SUMMARY

The following presents a simplified summary in order to provide a basic understanding. This summary is not an extensive overview. It is not intended to identify key/critical elements of the invention or to delineate the scope of the invention. Its sole purpose is to present some concepts of the invention in a simplified form as a prelude to the more detailed description that is presented later. Additionally, section headings used herein are provided merely for convenience and should not be taken as limiting in any way.

In accordance with one aspect of the invention, a mobile device is paired with a primary computer that issues the mobile device a self-signed access credential over a trusted connection such as a direct wired connection between the mobile device and the primary computer. The mobile device and the primary computer encrypt communications between the device using a self-signed access credential. In this manner, the mobile device and the primary computer each can verify the identity of the other and protect communications from eavesdroppers.

In accordance with another aspect of the invention, a mobile computing device can access a certificate repository to replace a lost or damaged access credential. By accessing the certificate repository, the mobile computing device can reestablish secure communication with a primary computer that was not possible without a good copy of an access credential. The mobile device can also avoid the necessity of physically connecting to the primary computer using a trusted connection.

In accordance with yet another aspect of the invention, a mobile device can access a certificate repository to obtain a copy of an access credential by authenticating with a verification component that controls access to the certificate repository. The verification component can use a challenge-response system to authenticate the mobile device. Once authenticated, the mobile device can obtain an access credential.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the subject invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 is a system block diagram of a mobile device authentication system in accordance with an aspect of the disclosed invention.

FIG. 2 is a system block diagram of a primary computer and mobile computing device paired system in accordance with another aspect of the disclosed invention.

FIG. 3 is a system block diagram of a communication system in accordance with an aspect of the disclosed invention.

FIG. 4 is a system block diagram of a mobile computing device communication system in accordance with a further aspect of the disclosed invention.

FIG. 5 is a system block diagram of a mobile computing device communication system in accordance with still another aspect of the disclosed invention.

FIG. 6 is a flow diagram depicting a method in accordance with another aspect of the disclosed invention.

FIG. 7 is a flow diagram depicting a general processing flow in accordance with yet another aspect of the invention.

FIG. 8 is a flow diagram depicting a general processing flow in accordance with still another aspect of the invention.

FIG. 9 is a flow diagram of a processing flow in accordance with a further aspect of the invention.

FIG. 10 illustrates an exemplary networking environment, wherein the novel aspects of the subject invention can be employed.

FIG. 11 illustrates an exemplary operating environment, wherein the novel aspects of the subject invention can be employed.

### DETAILED DESCRIPTION

The subject invention relates to systems and methods to facilitate the ranking of data. As used in this application, terms “component,” “system,” and the like are intended to refer to a computer-related entity, either hardware, software (e.g., in execution), and/or firmware. For example, a component can be a process running on a processor, a processor, an object, an executable, a program, and/or a computer. Also, both an application running on a server and the server can be components. One or more components can reside within a process and a component can be localized on one computer and/or distributed between two or more computers.

The subject invention is described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention. Additionally, although specific examples set forth may use terminology that is consistent with client/server architectures or may even be examples of client/server implementations, skilled artisans will appreciate that the roles of client and server may be reversed, that the subject invention is not limited to client/server architectures and may be readily adapted for use in other architectures, specifically including peer-to-peer (P2P) architectures, without departing from the spirit or scope of the invention.

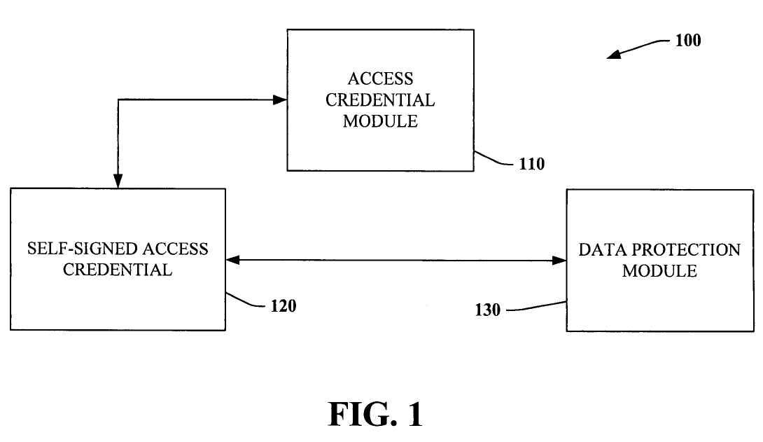

FIG. 1 is a system block diagram of a mobile device authentication system 100 in accordance with an aspect of the disclosed invention. The mobile device authentication system 100 includes an access credential module 110. The access credential module 110 creates a self-signed access credential 120. A data protection module 130 can use the self-signed access credential 120 to protect data either in storage on a mobile computing device or in transit to or from the mobile computing device.

An access credential module 110 can create a self-signed access credential 120 using a variety of cryptographic techniques, such as creating a security certificate. One example of a self-signed access credential is a certificate created by taking a copy of a private encryption key and encrypting that private key with itself. Therefore:
CERTIFICATE=KEY_{PRIV}+{KEY_{PRIV}}_{KEYpriv}.
Another example uses a public-private encryption key pair to create a certificate. The certificate is created using the private key of the pair to encrypt a copy of the public key. Thus:
CERTIFICATE=KEY_{PUB}+{KEY_{PUB}}_{KEYpriv}.
Certificates can be created in this manner for both a mobile computing device and a primary computer with which it is paired. These certificates are described as self-signed because the same encryption key (or one key of a pair) that is embodied in the certificate is used to sign the certificate. Such a certificate has properties that identify the holder of the certificate as a known entity to others that understand the certificate and how to use it.

Various uses for self-signed access credentials exist. These uses include identity verification, data encryption or decryption, and as an access control mechanism for secure networks. To verify the identity of a sender of data, a device can attempt to decrypt communications from the sender using a public or private encryption key known to be assigned to a specific sender. If the communication can be decrypted properly, a high level of confidence can be attached to the determination that the communication came from the identified sender. For access to secure networks, a connection can be permitted only to those devices that present a proper certificate in response to an authentication challenge.

An example of this system in operation follows. When a mobile computing device is to have a self-signed access credential assigned to it, the access credential module 110 creates a certificate. The access credential module can use a randomly generated key or can incorporate specific identifying information about the mobile computing device, for example, a serial number or identifying numbers of components, to generate the key and create the self-signed access credential. Once created, the data protection module uses a key portion of the self-signed access credential to encrypt or decrypt all communications to and from the mobile computing device.

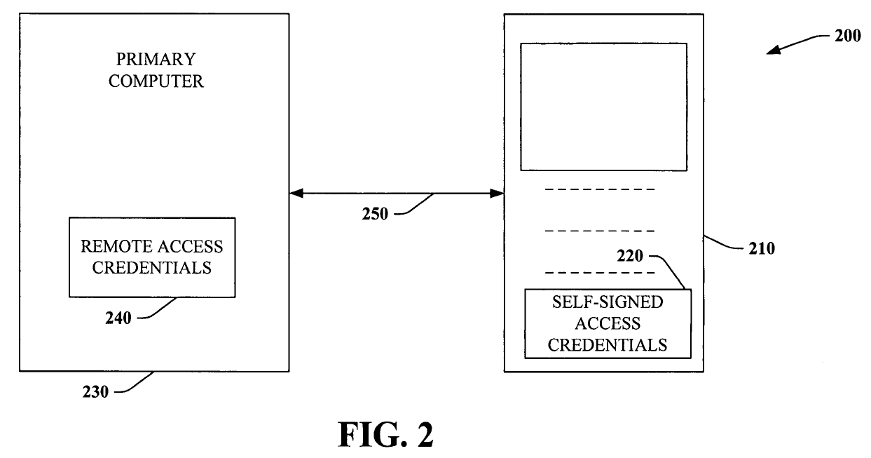

FIG. 2 is a system block diagram of a primary computer and mobile computing device paired system 200 in accordance with another aspect of the disclosed invention. The paired system 200 includes a mobile computing device 210 that includes a self-signed access credential 220. The mobile computing device 210 can be a personal information manager, a personal digital assistant, a palmtop computer, a cellular telephone, or another similar device. The mobile computing device 210 is paired with a primary computer 230 that includes a remote access credential 240. A pairing procedure is performed using a trusted connection 250.

The self-signed access credential 220 and the remote access credential 240 can be created as described above in conjunction with FIG. 1. The trusted connection can be a direct wire connection between the mobile computing device 210 and the primary computer 230 such as a USB or IEEE 1394 connection, among others. The trusted connection 250 can also be a wireless connection such as a Bluetooth or IEEE 802.11x connection. For pairing operations, the connection is trusted to ensure that third parties do not improperly obtain a copy of the access credentials of either the mobile computing device 210 or the primary computer 230.

One possible operational example is as follows. To take advantage of available computing and processing resources, the primary computer creates the self-signed access credential 220 and transmits it to the mobile device 210. The primary computer 230 also creates the remote access credential 240 for itself. When communicating with the other device of the pair, each of the paired devices uses its access credentials to encrypt communications. In this manner, future communications that may occur over an untrusted connection, such as the public Internet, can be protected from eavesdropping by third parties.

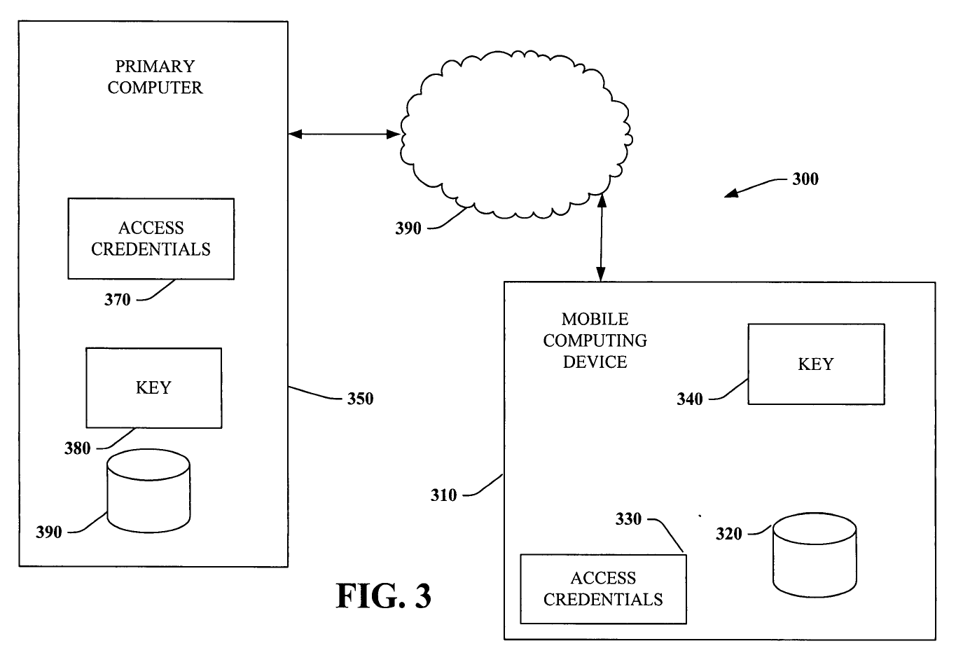

FIG. 3 is a system block diagram of a communication system 300 in accordance with an aspect of the disclosed invention. The system 300 includes a mobile computing device 310. The mobile computing device 310 includes a data store 320, an access certificate 330, and a key 340. A primary computer 350 includes a data store 360, an access certificate 370, and a key 380. The mobile communication device 310 is connected to the primary computer 350 through a network 390.

The data store 320 includes information of the mobile computing device 310. The access credentials 330 can be a security certificate as previously described. The key 340 is a key associated with the primary computer 350. This key 340 can be used by the mobile computing device 310 to decrypt any encrypted communications from the primary computer 350. In this manner, the mobile computing device 310 can verify that such communications indeed originated from the primary computer 350.

The data store 360 includes information of the primary computer 350. The access credentials 370 can be a security certificate as previously described. The key 380 is a key associated with the mobile computing device 310. This key 380 can be used by the primary computer 350 to decrypt any encrypted communications from the mobile computing device 310. In this manner, the primary computer 350 can verify that such communications indeed originated from the mobile computing device 310.

One example of an operational scenario is presented below. The mobile computing device 310 can initiate a data synchronization operation with the primary computer 350 by sending a request over the network 390 to the primary computer 350. The mobile computing device 310 can encrypt that request with the access credentials 330. Such encryption can serve to identify the mobile computing device 310 as the source of the request and also can serve to protect contents of the request from third parties.

The primary computer 350 can receive the data synchronization request from the mobile computing device 310 and can decrypt the request using the key 380. If the request decrypts properly using the key 380, the primary computer 350 can verify that the mobile computing device 310 indeed originated the request and that the request was not tampered with in transit. The primary computer 350 can then access the data store 360 to obtain data to send to the mobile computing device 310. That data can be encrypted by the primary computer 350 using the access credentials 370. Encrypted data can then be sent over the network 390 to the mobile computing device 310.

The mobile computing device 310 can decrypt information received using the key 340. If the request decrypts properly using the key 340, the mobile computing device 310 can verify that the primary computer 350 indeed originated the data and that the request was not tampered with in transit. The mobile computing device 310 can then use the data to update information in the data store 320.

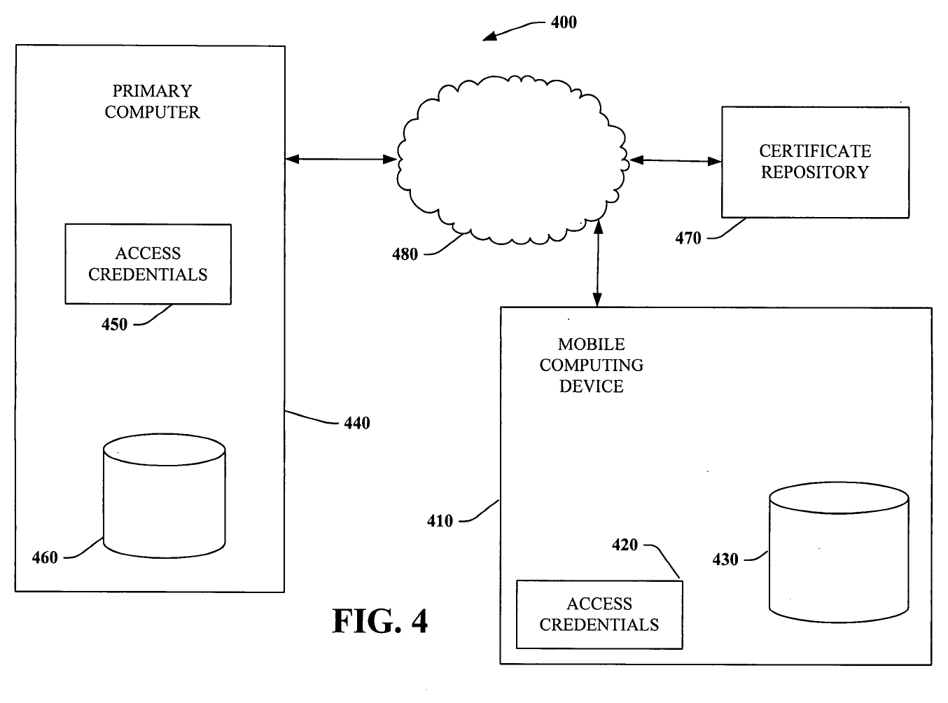

FIG. 4 is a system block diagram of a mobile computing device communication system 400 in accordance with a further aspect of the disclosed invention. The mobile computing device communication system 400 includes a mobile computing device 410 that itself includes access credentials 420 and a data store 430. A primary computer 440 includes access credentials 450 and a data store 460. A certificate repository 470 includes copies of access credentials of the mobile computing device 410 and the primary computer 440. The mobile computing device 410, the primary computer 440, and the certificate repository 470 can communicate using a network 480.

While separated from the primary computer 440, both the mobile computing device 410 and the primary computer 440 use the access credentials 420, 450, respectively, to communicate with each other over untrusted communication pathways. If one or both of the access credentials 420, 450 become corrupted or are otherwise rendered unusable, the mobile computing device 410 can no longer communicate with the primary computer 450. If the mobile computing device 410 is in the vicinity of the primary computer 450, the devices can be paired again over a trusted connection to reestablish connectivity. However, it is not always possible to use a trusted connection for this purpose without significant delays. The certificate repository 470 can be used to obtain a good copy of at least one of the access credentials 420, 450 to reestablish connectivity without pairing the devices again. The certificate repository 470 can also be used in a case where the mobile computing device 410 has been damaged and replaced with another unit.

An example of an operation along these lines follows. The access credentials 420 of the mobile computing device 410 become corrupted or otherwise unusable. The mobile computing device 410 can access the certificate repository 470 and can obtain a good copy of the access credentials 420. Using the newly-obtained good copy, the mobile computing device 410 can communicate with the primary computer 440. A similar procedure can be followed by the primary computer 440 to obtain a good copy of the access credentials 450.

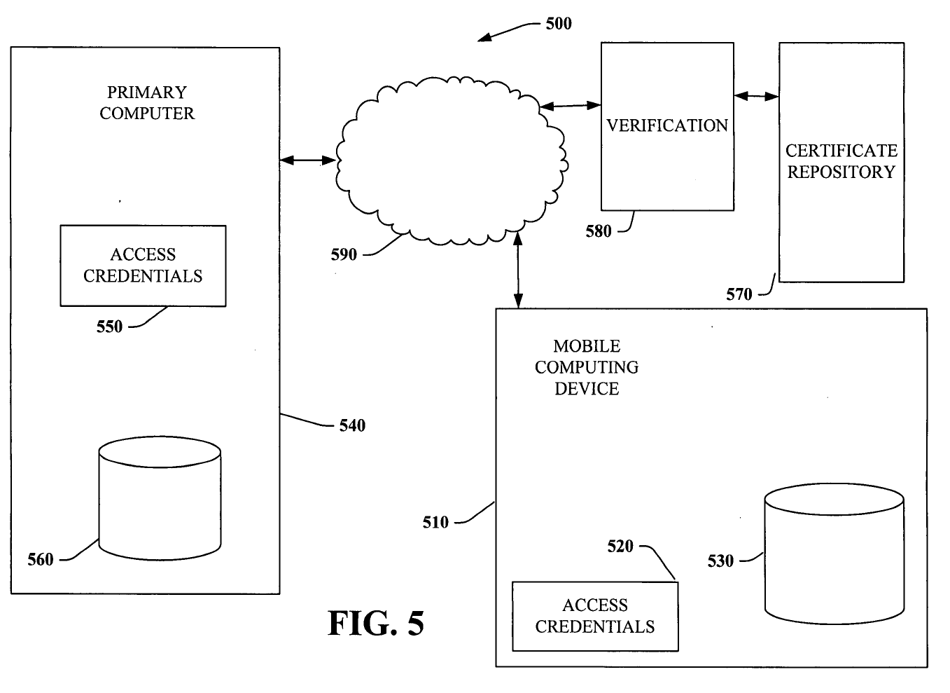

Introducing an ability for a mobile computing device to obtain access credentials from a source other than a primary computer with which it is paired can introduce security risks, for example, risks that a third party can improperly obtain access credentials. A system that can mitigate such risks is discussed with reference to FIG. 5. FIG. 5 is a system block diagram of a mobile computing device communication system 500 in accordance with still another aspect of the disclosed invention.

The mobile computing device communication system 500 includes a mobile computing device 510 that itself includes access credentials 520 and a data store 530. A primary computer 540 includes access credentials 550 and a data store 560. A certificate repository 570 includes copies of access credentials of the mobile computing device 510 and the primary computer 540. Access to the certificate repository 570 is controlled by a verification component 580. The mobile computing device 510, the primary computer 540, the certificate repository 570, and the verification component 580 can communicate using a network 590.

While separated from the primary computer 540, both the mobile computing device 510 and the primary computer 540 use the access credentials 520, 550, respectively, to communicate with each other over untrusted communication pathways. If one or both of the access credentials 520, 550 become corrupted or are otherwise rendered unusable, the mobile computing device 510 can no longer communicate with the primary computer 550. In this example, the verification module 580 restricts access to the certificate repository 570 to authorized users or devices. If the mobile computing device 510 can verify its identity to the verification component 580, the verification component 580 can allow the mobile computing device 510 to access the certificate repository 580.

The verification component 580 can be implemented in a variety of ways. One possible implementation is for the verification component 580 to simply allow access only to devices with known hardware identifiers, such as MAC addresses or other identifiers. Another implementation is as a web service. A user can use the mobile computing device 510 (or another computer) to login to a website to obtain permission to obtain a copy of access credentials. The website can issue one or more authentication challenges to the user to attempt to authenticate the user. Such challenges can include requests to verify information about the user such as a birthdate, a name of a favorite teacher, or some other appropriate challenge. If the user can successfully respond to the challenges, the verification component 580 can permit access to a copy of the access credentials desired.

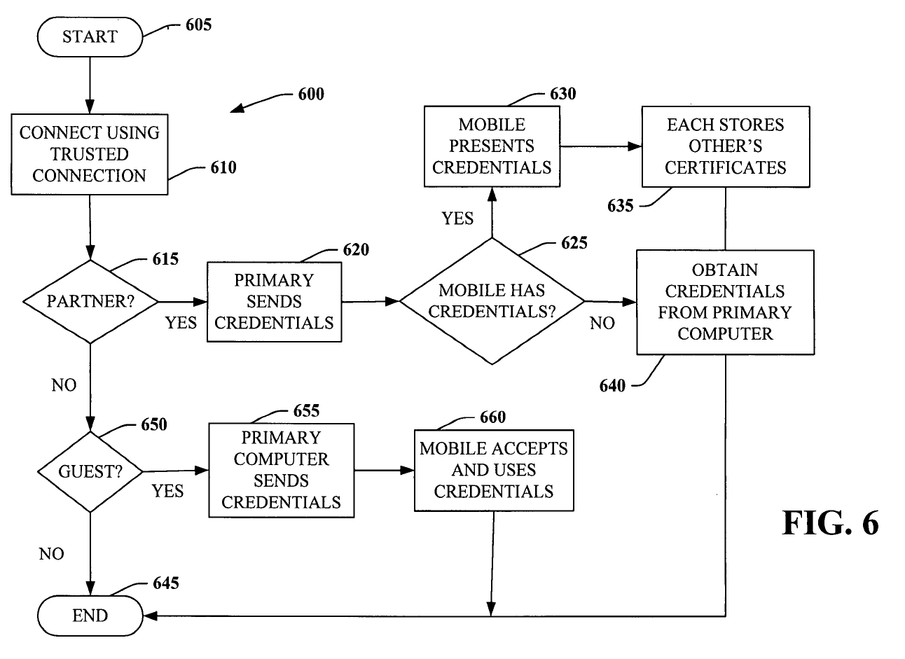

With reference to FIGS. 6-10, flowcharts in accordance to various aspects of the invention are presented. While, for purposes of simplicity of explanation, the one or more methodologies shown herein, for example, in the form of a flow chart, are shown and described as a series of acts, it is to be understood and appreciated that the subject invention is not limited by the order of acts, as some acts may, in accordance with the subject invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

FIG. 6 is a flow diagram depicting a method 600 in accordance with another aspect of the disclosed invention. Execution of the method 600 begins at START block 605 and continues to process block 610. At process block 610 a mobile device connects with a primary computer using a trusted connection. Processing continues to process block 615 where a determination is made whether the mobile device is already partnered with the primary computer. If yes, processing continues at process block 620 where the primary computer sends its credentials to the mobile device. At decision block 625, a determination is made whether the mobile device already has credentials. If yes, processing continues to process block 630 where the mobile device presents its credentials to the primary computer. At process block 635, the primary computer and the mobile device each store the credentials of the other. Processing then concludes at END block 645.

If the determination made at decision block 615 is no, processing continues to decision block 650 where a determination is made whether the mobile device can connect as a guest instead of a known or authenticated user. If yes, processing continues at process block 655 where the primary computer sends its credentials to the mobile device. At process block 660, the mobile device accepts the credentials of the primary computer and uses those credentials during a connection session. Processing concludes at END block 645. Similarly, if the determination made at decision block 650 is no, processing terminates at END block 645.

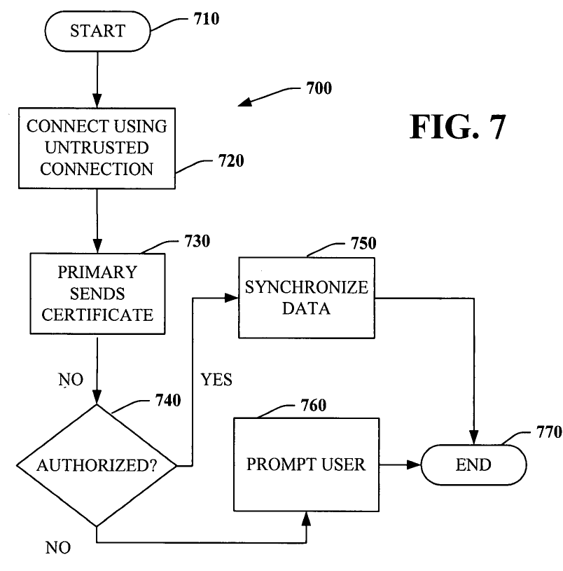

FIG. 7 is a flow diagram depicting a general processing flow 700 in accordance with yet another aspect of the invention. Processing begins at START block 710 and continues to process block 720. At process block 720, a mobile device connects to a primary computer over an untrusted connection path and presents its credentials to the primary computer. At process block 730, the primary computer presents its certificate to the mobile device. At decision block 740, a determination is made whether both the primary computer and the mobile device can authenticate each other using the appropriate security credentials.

If the determination made at decision block 740 is yes, processing continues to process block 750 where the mobile device synchronizes its data with data of the primary computer. If the determination is no, a prompt for a user is created and presented to inform the user that the mobile device cannot be authenticated and that no further connection will be allowed. Processing from either process block 750 or process block 760 concludes at END block 770.

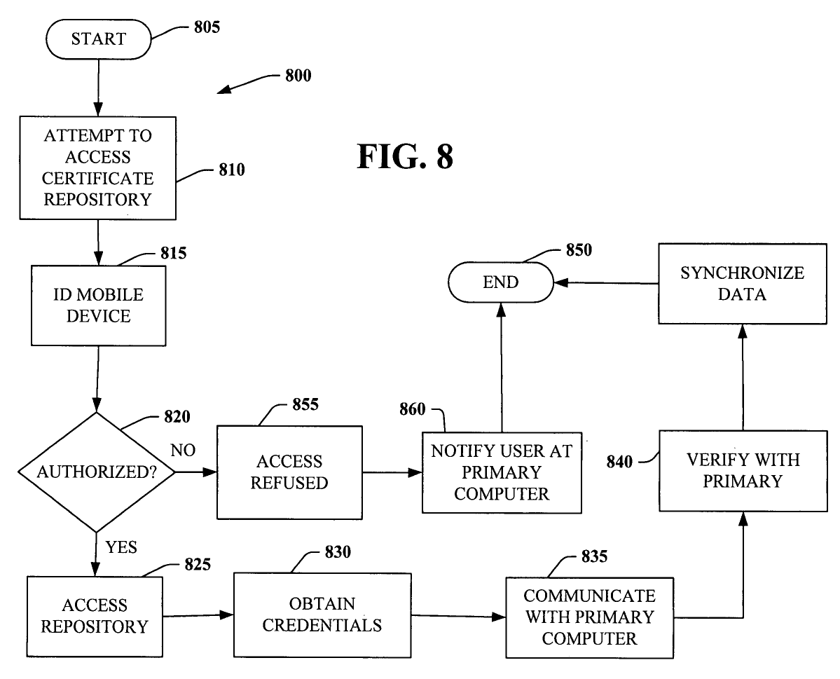

FIG. 8 is a flow diagram depicting a general processing flow 800 in accordance with still another aspect of the invention. The process begins execution at START block 805 and continues to process block 810. At process block 810 a mobile device attempts to access a certificate repository to obtain a copy of access credentials. Processing continues to process block 815 where the identity of the mobile device is ascertained. At decision block 820, a determination is made whether the mobile device is authorized to access the certificate repository. If yes, processing continues at process block 825 where the mobile device accesses the certificate repository. At process block 830, the mobile device obtains a copy of desired access credentials. Processing continues at process block 835 where the mobile device uses the obtained access credentials to communicate with a primary computer. At process block 840, the primary computer verifies the identity of the mobile device. A synchronization process is performed at process block 845. Processing concludes at END block 850.

If the determination made at decision block 820 is no, access for the mobile device is refused at process block 855. At process block 860, a notification that an attempt to obtain access credentials is sent to the primary computer. Processing concludes at END block 850.

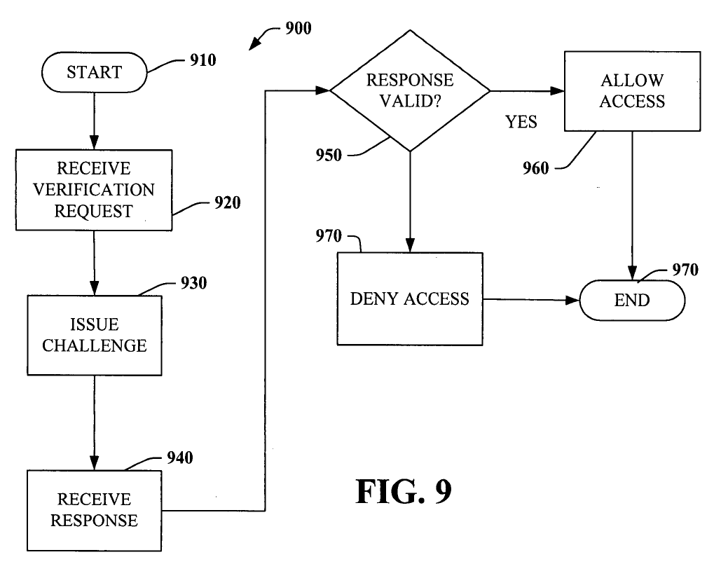

FIG. 9 is a flow diagram of a processing flow 900 in accordance with a further aspect of the invention. Processing begins at START block 910 and continues to process block 920 where a verification component that controls access to a certificate repository receives a verification request from a mobile device or through a web service or other suitable channel. Processing continues at process block 930 where the verification component issues an authentication challenge to the mobile device. At process block 940, the verification component receives a response from the mobile device.

Processing continues at decision block 950 where a determination is made whether the response received from the mobile device is valid. If yes, access is allowed at process block 960. If the determination is no, access is denied at process block 970. Processing from either process block 960 or process block 970 concludes at END block 980.

The subject invention, for example in connection with identification tasks, among others, can employ various artificial intelligence-based schemes for carrying out various aspects thereof. For example, a verification process for determining whether access should be permitted can be facilitated by using an automatic classifier system and process. Moreover, when more than one component is in use, for example, multiple connection requests, an automatic classifier system can be used to manage multiple communications and prevent overly redundant communications.

A classifier is a function that maps an input attribute vector, X=(x₁, x₂, x₃, x₄, . . . xₙ), to a confidence that the input belongs to a class, that is, ƒ(X)=confidence(class). Such classification can employ a probabilistic and/or statistical-based analysis (for example, factoring into the analysis utilities and costs) to prognose or infer an action that a user desires to be automatically performed. In the case of software component replacement systems, for example, attributes can be file descriptors such as filenames, signatures, hash functions, upgrade codes, compatibility codes, version numbers, build numbers, release dates, or other data-specific attributes derived from the device driver files and the classes are categories or areas of interest, for example, descriptors of other device drivers that the device driver can update.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to, training data. Other directed and undirected model classification approaches include, e.g., naïve Bayes, Bayesian networks, decision trees, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (for example, by a generic training data) as well as implicitly trained (for example, by observing user behavior, receiving extrinsic information). For example, SVM's are configured by a learning or training phase within a classifier constructor and feature selection module. Thus, the classifier(s) can be used to automatically perform a number of functions, including but not limited to determining whether a device should be sent data.

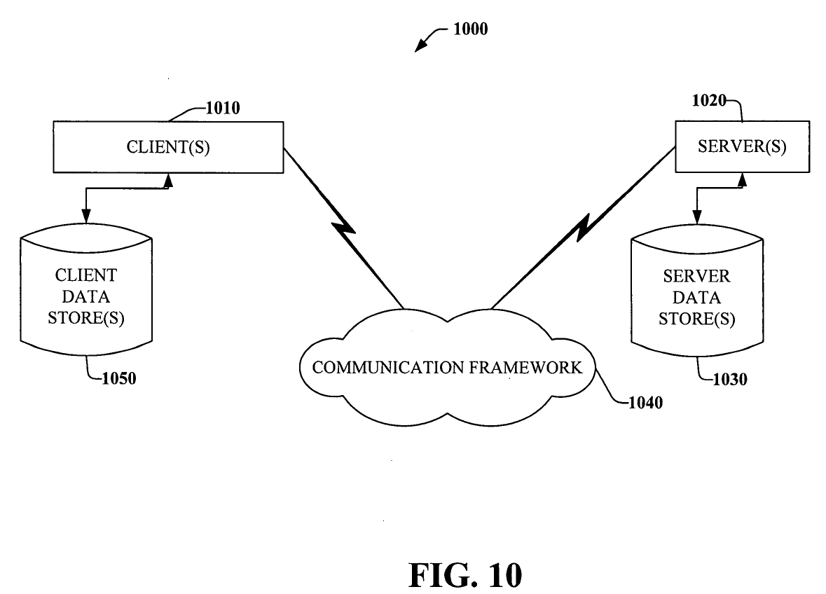

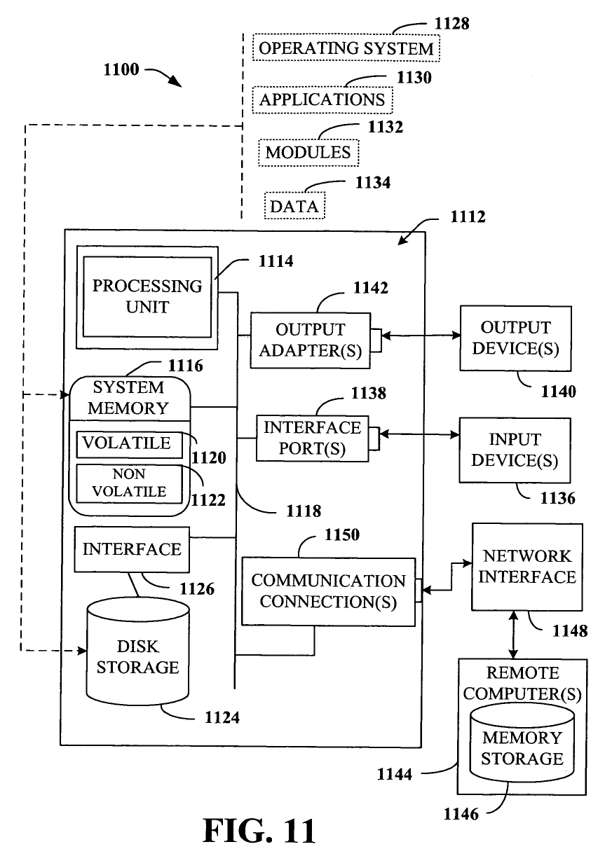

In order to provide additional context for implementing various aspects of the subject invention, FIGS. 10-11 and the following discussion is intended to provide a brief, general description of a suitable computing environment within which various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc. that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

FIG. 10 is a schematic block diagram of a sample-computing environment 1000 with which the subject invention can interact. The system 1000 includes one or more client(s) 1010. The client(s) 1010 can be hardware and/or software (e.g., threads, processes, computing devices). The system 1000 also includes one or more server(s) 1020. The server(s) 1020 can be hardware and/or software (e.g., threads, processes, computing devices). The servers 1020 can house threads or processes to perform transformations by employing the subject invention, for example.

One possible means of communication between a client 1010 and a server 1020 can be in the form of a data packet adapted to be transmitted between two or more computer processes. The system 1000 includes a communication framework 1040 that can be employed to facilitate communications between the client(s) 1010 and the server(s) 1020. The client(s) 1010 are operably connected to one or more client data store(s) 1050 that can be employed to store information local to the client(s) 1010. Similarly, the server(s) 1020 are operably connected to one or more server data store(s) 1030 that can be employed to store information local to the servers 1040.

With reference to FIG. 11, an exemplary environment 1100 for implementing various aspects of the invention includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable ROM (EEPROM), or flash memory. Volatile memory 1120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also includes removable/non-removable, volatile/non-volatile computer storage media. For example, FIG. 11 illustrates a disk storage 1124. The disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in the suitable operating environment 1100. Such software includes an operating system 1128. The operating system 1128, which can be stored on the disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the subject invention can be implemented with various operating systems or combinations of operating systems.

A user enters commands or information into the computer 1112 through input device(s) 1136. The input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system for authenticating a mobile computing device, comprising:
an access credential module that creates and uses a self-signed access credential that indicates that a mobile computing device possessing the access credential is trusted; and
a data protection module that applies the access credential to data used by the mobile computing device.

2. The system of claim 1, wherein the self-signed access credential is a public encryption key that is encrypted using a corresponding private encryption key.

3. The system of claim 1, wherein the self-signed access credential is a private encryption key that is encrypted using itself.

4. The system of claim 2, further comprising a remote access credential module that is paired with the access credential module for data communication.

5. The system of claim 4, further comprising a trusted credential repository that can be accessed by the mobile computing device to obtain a copy of the self-signed access credential.

6. The system of claim 2, further comprising a data transfer module that manages a data transfer between the mobile computing device and a remote computer.

7. The system of claim 6, wherein the access credential module is a module of a computer with which the mobile computing device can communicate.

8. The system of claim 5, further comprising an identity verification module that verifies an ability of a mobile computing device to access the copy of the self-signed access credential.

9. A method for protecting data communications of a mobile computing device, comprising:
creating, on a computer, a self-signed security certificate that is assigned to an identified mobile computing device; and
using the self-signed security certificate to protect data communications of the identified mobile computing device.

10. The method of claim 9, wherein creating the self-signed security certificate includes using a private encryption key to encrypt a copy of itself.

11. The method of claim 9, wherein creating the self-signed security certificate includes using a private encryption key of a public-private encryption key pair to encrypt a public encryption key of the public-private encryption key pair.

12. The method of claim 11, further comprising pairing the identified mobile computing device with a primary computer for data communications.

13. The method of claim 1 1, further comprising sending a copy of the self-signed security certificate to a trusted repository.

14. The method of claim 13, further comprising verifying permission of a mobile computing device to access a copy of the self-signed security certificate of the trusted repository.

15. A system for protecting data communications of a mobile computing device, comprising:
means for creating a self-signed security certificate that is assigned to an identified mobile computing device; and
means for using the self-signed security certificate to protect data communications of the identified mobile computing device.

16. The system of claim 15, wherein the means for creating the self-signed security certificate includes means for using a private encryption key to encrypt a copy of itself.

17. The system of claim 15, wherein the means for creating the self-signed security certificate includes means for using a private encryption key of a public-private encryption key pair to encrypt a public encryption key of the public-private encryption key pair.

18. The system of claim 17, further comprising means for pairing the identified mobile computing device with a primary computer for data communications.

19. The system of claim 17, further comprising means for sending a copy of the self-signed security certificate to a trusted repository.

20. The system of claim 19, further comprising means for verifying permission of a mobile computing device to access a copy of the self-signed security certificate of the trusted repository.
